(19) United States
(12) Patent Application Publication
(10) Pub. No.: US 2005/0195848 A1
(43) Pub. Date: Sep. 8, 2005

(54) Method and system for the initialization and validation of the setting up or transfer of a connection in a communications network, corresponding terminals and remote-control unit

(75) Inventors: Mohamed Braneci, Rennes (FR); Emmanuel Raguet, Le Rheu (FR)

Correspondence Address: FITZPATRICK CELLA HARPER & SCINTO, 30 ROCKEFELLER PLAZA, NEW YORK, NY, 10112, US

(73) Assignee: CANON EUROPA NV, Amstelveen (NL)

(21) Appl. No.: 11/052,838

(22) Filed: Feb. 9, 2005

(30) Foreign Application Priority Data
Feb. 9, 2004 (FR) 04 01239

(51) Int. Cl. H04L 12/28

(52) U.S. Cl. 370/421

(57) ABSTRACT

Disclosed is a method for communicating audiovisual signals over a communication network interconnecting a plurality of devices, wherein the method comprising the steps of: selecting an audiovisual signal at a first device; transmitting an indication message from the first device to a group of devices over the communication network, said indication message containing a set of parameters associated to the selected audiovisual signal; selecting a second device among the group of devices, said selection being performed at said second device; and establishing a connection for retrieving at the selected second device the audiovisual signal using at least one of the set of parameters.

### BACKGROUND OF THE INVENTION

1. Field of the Invention

The field of the invention is that of communications networks interconnecting a plurality of terminals.

More specifically, the invention relates to methods and devices for communicating audiovisual signals over the communication network by initializing and validating the setting up or the transferring of a connection.

In the case of the setting up of a connection, it is assumed that a first connection has to be set up between a source terminal and a first destination terminal.

In the case of the transfer of a connection, it is assumed that the above-mentioned first connection has already been set up and that it is desired to transfer this connection toward (at least) one second destination terminal. It will be noted that the first connection can be kept or not kept after it has been transferred, i.e. after the second connection has been set up. In other words, the term “transfer of connection” is understood to mean both a change of connection (this is the case where the first connection is not kept) and an addition or juxtaposing of connections (this is the case where the first connection is kept).

The present invention can be applied with different structures of communications networks. This network is, for example, a simple bus or again a network comprising a plurality of nodes connected by links.

The invention can be applied especially but not exclusively to the setting up or transfer of a connection within a home audiovisual network, for which an example of an embodiment is presented briefly here below.

Such a home network comprises for example a plurality of serial communications buses according to the IEEE 1394 standard, each typically covering one room of the dwelling. The buses are attached to a backbone network through devices called “nodes”. The backbone network is, for example, a high-bit-rate switched type network with links enabling two-way data transfers according to the IEEE 1355 standard. The backbone network may also be a serial type of network according to the IEEE 1394b or Ethernet standard. It may also be a wireless network using, for example, a radio type of medium accordingly the IEEE 802.11 or ETSI BRAN HiperLAN/2 standards.

The present invention covers both the case where the source terminal is independent and connected to a node (input node) and the case where the source terminal is integrated with a node (source node).

Similarly, the present invention covers both the case where a destination terminal is independent and connected to a node and the case where the destination terminal is integrated into a node.

The term device is used hereinafter when referring to either a terminal or a node indistinctly.

A terminal is, for example, a television receiver or “tuner unit”, a videocassette recorder, a cinema camera, a camera, a DVD reader, an Internet access point, etc. This list is of course not exhaustive.

2. Description of the Prior Art

The IEEE 1394 standard relates to the configuration and management of a serial communications bus enabling the connection of a set of digital terminals to one another. Terminals connected to different IEEE 1394 buses (each in one room for example) may communicate through the two nodes to which their buses are connected. The two nodes as well as the backbone network that connects them forms a “heterogeneous bridge”. The management and configuration of communications through the heterogeneous bridge (addressing, the setting up of the connection, routing, etc.) are for example those described in a new standard, the IEEE P1394.1 standard which presently exists in the form of a draft version 1.04, dated 25 Oct. 2002.

A digital terminal may be at least one of the following three types of terminals:
a source terminal or “talker” is a terminal that can give audiovisual (AV) signals;
a destination terminal or “listener” is a terminal that can receive audiovisual signals;
a controller terminal or controller is a terminal responsible for setting up/modifying/breaking a connection between a source terminal and one or more destination terminals

A controller terminal can also be integrated into a node of the backbone network. Here below in the description of the invention, the node to which a destination terminal is attached, hereinafter called the link-up node, is chosen to be the controller of the connection.

Typically, each source terminal or destination terminal has a control module enabling the exchange of messages with the controller terminal and the internal configuration of the terminal for sending or reception operations. For example in the IEC 61883-1 standard (Digital Interface for Consumer Electronic Audio/Video Equipment) of 1998, the transmission of an audiovisual signal is controlled by and “output Plug Control Register” or iPCR located in the source terminal and the reception of an audiovisual signal is controlled by an “input Control Plug Register” or iPCR) located in the destination terminal. The transmission of the audiovisual signal may be controlled by the controller in modifying the corresponding control plug registers through the management of asynchronous messages. The control modules of the terminals may themselves command the transmission of the audiovisual signal, in making internal modifications of their respective registers. The control module also enables the exchange of high-level command messages, through the IEEE 1394 buses, to enable a terminal to play or stop. The set of possible commands depends on the equipment. These commands are described for example in the AV/C (“Audio/Video Control”) specifications, published by the “1394 Trade Association”.

There may also be analog terminals present in the home network. These terminals may be connected to an IEEE 1394 bus through digital/analog adapters. These adapters make an analog terminal visible and accessible to the other terminals of the home network. An adapter comprises an analog-digital conversion and/or digital-analog conversion function and a control module. The conversion function enables the conversion, for example, of an analog audiovisual signal into a digital audiovisual signal in a certain format (DV, MPEG, etc.) and/or inversely depending on the direction of the transmission. The control module enables the translation of the command messages sent to or coming from the analog terminal, and thus represents this analog terminal during exchanges with the controller terminal for example.

An adapter may take the form of an independent device or it may be integrated into a node of the backbone network. In the latter case, in addition to an IEEE 1394 Interface for the connection of digital terminals, the node will comprise an analog audiovisual interface for the input and/or output of analog audiovisual signals and an interface, of the infrared type for example, for the exchange of control commands with the analog terminal.

The digital and/or, analog terminals belong for example to the following list of equipment (which is not exhaustive): television receivers (using satellite, RF, cable, xDSL and other means), television sets, videocassette recorders, scanners, digital cinema cameras, digital cameras, DVD readers, computers, personal digital assistants (PDAs), printers, etc.

Through the home network, the source and destination terminals and the controllers distributed in the different rooms of a house may contribute to the distribution of audiovisual signals in the house and perform a service for the user. Thus, it not necessary for the source terminal to be close to the destination terminal or integrated into it. For example, in the case of a network formed by a videocassette recorder and several television sets distributed among the different rooms of a house, the user is not required to watch a recording on the television set that is placed beside the videocassette recorder but can do so on any other television set of the house connected to the network.

It can be seen that, at present, setting up a connection in a home audiovisual network presented here above is a relatively complex procedure for the user. Indeed, through a menu of a man/machine interface managed by a piece of equipment (a node or terminal) of the network, the user must select a source terminal and the destination terminal. The greater the number of terminals connected to the network, the more difficult is it to use this menu. Furthermore, the user must be capable of identifying each of these terminals.

Furthermore, it is very important to be able to offer users the possibility of transferring connections in a home audiovisual network as presented here above. It is indeed preferable to transfer a connection (which amounts to moving a service) from a first destination terminal to a second destination terminal in which the user is located, rather than ask this user to move toward the first destination terminal (namely the place in which the service is located). Again, when the user moves in the house, he should be able to start using a service (through connection to a piece of source equipment) provided by a first destination terminal, and should be able to continue using this same service from a second destination terminal that may be located in a different place, in making a transfer of the service.

A transfer of connection is worthwhile only if it is simpler for the user than implementing the entire lengthy and complex phase (see above discussion) for setting up a new connection. However, until now, there has been no satisfactory technical solution for carrying out a transfer of connection in a communications network, especially in a home audiovisual network.

Typically, to make a transfer of connection, the user, working through a menu of a man/machine interface managed by a piece of equipment of the network (a node or terminal), must select a connection that has already been set up (between a source terminal and a first destination terminal) as well as a second destination terminal. Just as in the procedure for setting up a connection (see above discussion), this transfer procedure is relatively complex for the user.

It has therefore been proposed to simplify this connection transfer procedure. Thus, in the prior art there is a known service transfer system described in the patent document W00034891 that uses:
a portable object handed over to the user and forming a transfer means;
a means of association, included in the first destination terminal and enabling the association of a selected service with the portable object;
a detection means, included in the destination terminal and enabling the detection of the portable object (after the user has conveyed it from the first destination terminal to the second destination terminal), and then the identification of the selected service associated with this portable object, and finally the activation of the identified service (thus achieving the transfer of the service from the first destination terminal to the second destination terminal).

One drawback of the system described in the patent W00034891 is that the user must carry a portable object when he moves from the first destination terminal to the second destination terminal. He therefore does not have his hands free while moving about.

Another drawback of this known system is that the portable object to be carried is not always at the place where the user needs it. For example, the portable object may be located not beside the first destination terminal, but in the vicinity of another terminal when the user wishes to make a transfer of service. The user may have also forgotten the last location of the portable object or may not know this location. He may even lose the object.

Yet another drawback of this prior art system is that the portable object to be transported is an additional object to be manipulated, and cannot be integrated into already present portable objects such as the remote-control units associated with the terminals and/or the nodes. Indeed, each of these remote-control units must remain close to the terminal and/or node with which they are associated.

Yet another drawback of this prior art system is that it does not enable the performance of numerous, and possibly simultaneous, transfers from a first destination terminal to several second destination terminals, and more generally it does not enable the transfer of several audiovisual signals from several first destination terminals to several second destination terminals simultaneously.

### SUMMARY OF THE INVENTION

It is a goal of the invention especially to overcome the different drawbacks of the prior art.

More specifically, one of the goals of the present invention is to provide a method and a device for distributing audiovisual signals by setting up or transferring a connection that is simpler to implement and especially does not oblige the user to selection terminals (source and/or destination terminals) through a menu of a man/machine interface.

It is yet another goal of the invention to provide a method and a device for a connection transfer that does not oblige the user to carry a portable object when he moves from the first destination terminal to the second destination terminal.

It is also a goal of the invention to provide a method and device of this kind that do not necessitate any additional object to be handled.

It is yet another goal of the invention to provide a method and device of this kind that enable the performance of numerous transfers and, if necessary, simultaneous transfers from several first destination terminals toward several second destination terminals.

It is yet another goal of the invention to ease the interaction of the user with the system for transferring or pausing an audiovisual signal.

These different goals, as well as others that shall appear here below, are achieved according to the invention by means of a method for communicating audiovisual signals over a communication network interconnecting a plurality of devices, wherein the method comprising the steps of
selecting an audiovisual signal at a first device;
transmitting an indication message from the first device to a group of devices over the communication network, said indication message containing a set of parameters associated to the selected audiovisual signal; and
selecting a second device among the group of devices, said selection being performed at said second device;
establishing a connection for retrieving at the selected second device the audiovisual signal using at least one of the set of parameters.

The invention also relates to a method for communicating audiovisual signals over a communication network interconnecting a plurality of devices, wherein the method comprising the steps of:
selecting an audiovisual signal at a first device;
transmitting an indication message from the first device to a predetermined second device over the communication network, said indication message containing a set of parameters associated to the selected audiovisual signal; and
selecting a third device among the plurality of devices, said selection being performed at said third device;
transmitting a request message for getting from the predetermined second device at least one of the set of parameters associated to the selected audiovisual signal; and
establishing a connection for retrieving at the selected third device the audiovisual signal using the at least one of the set of parameters.

The invention relates also to a device for communicating audiovisual signals over a communication network interconnecting a plurality of devices, comprising:
means for inputting first selection data causing the selecting of an audiovisual signal;
means for transmitting an indication message to a group of devices over the communication network, said indication message containing a set of parameters associated to the selected audiovisual signal;
means for receiving a set-up message regarding the selected audiovisual signal from at least one device of the group of devices; and
means for causing to establish a connection for the at least one device in response to the received set-up message to retrieving the selected audiovisual signal.

According to another aspect, the invention relates to a device for communicating audiovisual signals over a communication network interconnecting a plurality of devices, comprising:
means for receiving one or more indication messages, each indication message containing a set of parameters associated to an audiovisual signal;
means for inputting first selection data causing the selecting of a destination device;
means for determining one audiovisual signal from a list of audiovisual signals, the list being formed based on the received indication messages; and
means for establishing a connection for retrieving at said destination device the audiovisual signal in response to the determination means using at least one of the set of parameters.

Advantageously, the set of parameters comprises the identifier of an original destination device and said device comprises further a means for outputting indicative data for indicating if the identifiers of the original destination device and the selected destination device are equal or not.

Depending on the location of the user, the list of audiovisual signals to be retrieved is ordered differently. This makes the selection of an AV signal among several AV signals easier as it is most likely, if the storage service is used (time-shifting), to retrieve the AV signal for the same device from which the initial selection was performed.

In an advantageous variant, the determining means comprises means for inputting second selection data; and means for selecting the one audiovisual signal among the list of audiovisual signals using said second selection data.

In another advantageous variant, the device further comprises a transmitting means and wherein the receiving of one or more indication messages by the receiving means is performed in response to the transmitting of a request message by the transmitting means.

It is thus not necessary to transmit the indication message from the beginning to all devices. The indication message is transmitted upon request only to those devices having a need for it. This is suitable for a centralized approach.

According to another aspect, the invention relates to a method for initializing the setting up of a first connection between a source terminal and a first destination terminal, or for the transfer of the first connection consisting in the setting up of a second connection between the source terminal and a second destination terminal, the source terminal and the first and second destination terminals being connected to a communications network interconnecting a plurality of terminals. According to the invention, this method comprises the following successive steps:
(a) the detection of a setup-initializing or transfer-initializing signal
(b) the determining of the first connection to be set up or transferred, comprising the determining of the source terminal for setting up the first connection, or of the first destination terminal for the transfer of the first connection;
(c) the transmission in the network of a setup or transfer indication message in order to set up or transfer the first connection, the indication message comprising parameters of the first connection and an identifier of the source terminal, for the setting up of the first connection, or an identifier of the first destination terminal for the transfer of the first connection.

The general principle of the invention therefore consists in initializing the setting up or transfer of a connection and in making an indication message pass through the network. As explained in detail here below, this indication message enables the validation of the setting up or transfer of the connection concerned.

Thus, the user has no portable object to carry when he moves about. The present invention therefore makes it possible to overcome all the abovementioned drawbacks related to the notion of the carrying of a portable object.

The invention also enables the performance of numerous transfers since a same transfer indication message can be used in several second destination terminals. These numerous transfers can even be made simultaneously if several users act at the same time with different second destination terminals (or different second pieces of equipment associated with these second destination terminals).

In practice, certain terminals (or their associated pieces of equipment) can behave at certain times like a first destination terminal (or a first associated piece of equipment) and at other times like a second destination terminal (or a associated second piece of equipment). In this case, they must include the means to perform the steps proper to the two roles that they have to be capable of fulfilling.

Advantageously, the step (c) is performed without conditions.

In an advantageous variant, the step (c) is performed only if a request for transmission of an indication message is detected.

Preferably, in the case of this advantageous variant, the step (b) is followed by a step for the storage of the indication message or of information used to prepare the indication message, in association with an identifier proper to the indication message, and the step (c) is performed only if the detected request for transmission of an indication message includes an identifier proper to the indication message.

During the initialization step, the identifier proper to the identification message is either generated automatically (and the user is then informed of it), or it is given by the user. During the validation phase, the user must give this identifier proper to the identification message, so that it can be inserted into the request for transmission of an indication message. In other words, it is the identifier proper to the identification message that forms the link between the two phases and enables the transmission of the right indication message in the network.

In a preferred embodiment of the invention, the steps (a), (b) and (c) are performed by the source terminal or by a piece of equipment that is associated with it, for setting up the first connection, or by a first destination terminal or by a piece of equipment that is associated with it, for the transfer of the first connection.

Thus, in the initializing phase, the user interacts with a source terminal (or its associated piece of equipment) for the setting up of the first connection, or with the first destination terminal (or its associated piece of equipment) for the transfer of the first connection.

In an advantageous embodiment of the invention, the steps (a) and (b) are indistinguishable from each other, the detection of the initializing signal implying the default determining of the first connection in which the source terminal has to be involved, for the setting up of the first connection, or in which the first destination terminal is involved, for the transfer of the first connection.

Thus, the interactions of the user are minimized during the initialization phase.

Advantageously, each terminal is of the digital or analog type, and the pieces of equipment associated with the terminals belong to the group comprising:
adapters associated with analog type terminals;
nodes of the communications network to which terminals are connected.

The invention may, for example, be implemented:
either solely in the digital terminals;
or solely in the digital terminals and the adapters of the analog terminals;—or solely in the nodes;
or solely in the digital terminals and the nodes;
or in the digital terminals, the adapters of the analog terminals and the nodes.

It is furthermore recalled that the adapters may be integrated into the nodes.

Preferably, the initializing signal is a first remote-control signal sent by a first remote-control unit associated with the source terminal or with the equipment that is associated with it, for the setting up of the first connection, or associated with the first destination terminal or the piece of equipment that is associated with it, for the transfer of the first connection.

The first remote-control pack according to the invention can be integrated into the remote-control unit classically associated with the source terminal (or its associated piece of equipment), for setting up the first connection, or with the first destination terminal (or its associated piece of equipment), for the transfer, of the first connection.

The invention also relates to a method for validating the setting up of a first connection between a source terminal and a first destination terminal, or for the transfer of the first connection consisting of the setting up of a second connection between the source terminal and a second destination terminal, the source terminal and the first and second destination terminals being connected to a communications network interconnecting a plurality of terminals. According to the invention, this method comprises the following successive steps:
(i) the detection of a setup-validation or transfer-validation signal;
(ii) the determining of the first destination terminal for the setting up of the first connection, or of the second destination terminal for the transfer of the first connection;
(iii) the setting up or transfer of the first connection, as a function of the result of the step (ii) and of a connection setup indication message or transfer indication message, received through the network and comprising parameters of the first connection and an identifier of the source terminal, for the setting up of the first connection, or an identifier of the first destination terminal, for the transfer of the first connection.

Advantageously, the indication message is transmitted in the network without conditions.

In one advantageous variant, the indication message is transmitted in the network only if the step (i) is followed by a step of transmission in the network of a request for transmission of an indication message.

Preferably, in the case of this, advantageous variant, the request for transmission of an indication message comprises an identifier proper to the indication message whose transmission is required.

In a preferred embodiment of the invention, the steps (i) and (ii) are performed by the first destination terminal or a piece of equipment associated with it, for the setting up of the first connection, or the second destination terminal or -a piece of equipment that is associated with it, for the transfer of the first connection.

Thus, in the validation phase, the user interacts with the first destination terminal (or its associated piece of equipment) to set up the first connection, or with the second destination terminal (or its associated piece of equipment) for the transfer of the first connection.

In an advantageous embodiment of the invention, the steps (i) and (ii) are indistinguishable, the detection of the validation signal implying the default determining of the first connection in which the first destination terminal must be involved for the setting up of the first connection, or the second destination terminal for the transfer of the first connection.

Thus, the interactions of the user during the initialization phase are minimized.

Advantageously, the step (iii) is performed by a controller connected to the network.

Preferably, the controller is indistinguishable from the first destination terminal or the piece of equipment that is associated with it, for the setting up of the first connection, or from the second destination terminal or the piece of equipment that is associated with it, for the transfer of the first connection.

Advantageously, each terminal is of a digital or analog type, and the pieces of equipment associated with the terminals belong to the group comprising:
adapters associated with analog type terminals;
nodes of the communications network to which terminals are connected.

Preferably, the validation signal is a second remote-control signal sent by a second remote-control unit associated with the first destination terminal or with the piece of equipment associated with it, for the setting up of the first connection, or associated with the second destination terminal or the piece of equipment associated with it, for the transfer of the first connection.

The second remote-control unit according to the invention may be integrated into the remote-control unit classically associated with the first destination terminal (or with its associated piece of equipment), for the setting up of the first connection, or with the second destination terminal (or its associated piece of equipment), for the transfer of the first connection.

Preferably, each connection setup or transfer indication message has a limited duration of validity.

Thus, the processing operations performed by the terminals or the associated pieces of equipment are optimized. The user is also spared any confusion between a new connection setup operation (or transfer operation respectively) and an earlier connection setup operation (or transfer operation respectively) that was never validated.

Advantageously, the limited duration of validity of each indication message is managed in each terminal or its associated piece of equipment by a time-out mechanism such that:
after reception of the indication message, the terminal or its associated piece of equipment stores the indication message and activates a timeout;
if the connection to which the indication message pertains is set up or transferred in involving the terminal before the expiry of the time-out, the terminal or its associated piece of equipment resets the time-out and erases the previously stored indication message;
if the time-out expires without the setup or transfer of the connection to which the indication message pertains, in involving the terminal, the terminal or its associated piece of equipment resets the time-out at zero and erases the previously stored indication message.

According to an advantageous variant, the limited duration of the validity of each indication message is managed in each terminal or its associated piece of equipment by a transfer-confirming mechanism such that:
if the connection to which the indication message pertains is set up or transferred in involving the terminal, the terminal or its associated piece of equipment erases the previously stored indication message and sends a message on the end of setup or transfer to the other terminals or associated pieces of equipment;
after reception of the end of setup or transfer message, each of the, other terminals or associated pieces of equipment erases the previously stored indication message pertaining to the connection that has been set up or transferred.

Advantageously, the limited duration of validity of each indication message is managed in the terminal or its associated piece of equipment by a combination of the time-out mechanism and of the transfer-confirming mechanism.

Thus, if the setup-confirming or transfer-confirming mechanism is not applicable (in the case where it is never validated), then the time-out mechanism is applicable and enables an erasure of the indication message stored for this non-validated setting up or transfer operation.

The invention also relates to a method for setting up a first connection between a source terminal and a first destination terminal, or for the transfer of the first connection consisting in setting up a second connection between the source terminal and a second destination terminal.

According to the invention, this method comprises:
an initialization phase comprising the steps of the above-mentioned method for initializing the setting up or transfer of a first connection;
a validation phase comprising the steps of the above-mentioned method for validating the setting up or transfer of a first connection.

In a first particular embodiment of the invention, the initialization signal and the validation signal are identical and each constitutes a generic setting up or transfer (“follow-me”) signal. After the detection of a generic signal in the sense of the step (a) or (i), each terminal or its associated piece of equipment determines whether or not it stores the contents of an previously received indication message so that:
if the answer is negative, the terminal or its associated piece of equipment behaves like the source terminal or the piece of equipment associated with it, for the setting up the first connection, or like the first destination terminal or the piece of equipment that is associated with it, for the transfer of the first connection, and performs the steps (b) and (c);
if the answer is in the affirmative, the terminal or its associated piece of equipment behaves like the first destination terminal or the piece of equipment associated with it, for the setting up the first connection, or like the second destination terminal or the piece of equipment that is associated with it, for the transfer of the first connection, and performs the step (ii).

Thus, the user presses for example the same button of a remotecontrol unit to initialize or validate a connection setup or transfer operation. The terminal (or its associated piece of equipment) before which it is located will behave differently depending on whether or not it stores an indication message.

In a second particular embodiment of the invention, the initialization (Get) signal and the validation (“Push”) signal are not identical. The set of steps (a) to (c) can be iterated several times, with a same terminal or its associated piece of equipment, or again with different terminals or their associated pieces of equipment, so that several indication messages, pertaining to a plurality of connections to be set up or transferred, can be broadcast on the network. Each of the terminals or its associated piece of equipment manages a list of connections to be set up or transferred, and stores the contents of the corresponding indication messages received. The method comprises an additional step (ii) for determining the connection to be set up or transferred from the list of connections to be set up or transferred, the result of the additional step (ii′) being taken into account to perform the step (iii). The set of steps (ii), (ii′) and (iii) may be iterated several times with the same terminal or its associated second piece of equipment, or again with different terminals or their associated pieces of equipment, so that several connections can be set up or transferred.

The user has for example a remote-control unit comprising especially two buttons that can be used respectively to initialize and validate a connection setup or transfer operation. The user presses one of the two buttons when he wishes the terminal (or associated piece of equipment) before which he is located to behave like a source terminal (for setting up the first connection) or like a first destination terminal (for the transfer of the first connection). He presses the other of the two buttons when he wishes the terminal (or associated piece of equipment) before which he is located to behave like a first destination terminal (for setting up the first connection) or like a second destination terminal (for the transfer of the first connection).

This second particular embodiment of the invention is slightly more complex than the first one, because it necessitates the management of connection lists to be set up or transferred. As a trade-off, it offers the advantage of enabling easy management of numerous setup or transfer operations, if necessary simultaneously, (but without confidentiality) between a plurality of users. Indeed, several setup or transfer operations can be initialized within the network even before one of them is validated. However, in the above-mentioned first embodiment, a new setup or transfer operation within the network can be initialized only when the previous one is validated (or when the time to do so has elapsed, if the time-out mechanism described here below is implemented).

In an advantageous embodiment of the invention, during the step (b), a confidential code is obtained and associated with the first connection to be set up or transferred. The connection setup or transfer indication message, transmitted in the step (c), furthermore comprises the confidential code. During the step (ii), the user must furthermore provide the confidential code to permit the performance of the step (iii).

Advantageously, during the step (b), the confidential code is generated automatically, and the user is informed about it.

According to an advantageous variant, during the step (b), the user gives the confidential code.

The invention also relates to a system for initializing the setting up a first connection between a source terminal and a first destination terminal, or for the transfer of the first connection consisting in setting up a second connection between the source terminal and a second destination terminal, the source terminal and the first and second destination terminals being connected to a communications network interconnecting a plurality of terminals. According to the invention, this system comprises:
means for the detection of a setup-initializing signal or transfer-initializing signal
means for determining the first connection to be set up or transferred, comprising the determining of the source terminal for setting up the first connection, or of the first destination terminal for the transfer of the first connection;
means of transmission in the network of a setup or transfer indication message in order to set up or transfer the first connection, the indication message comprising parameters of the first connection and an identifier of the source terminal, for the setting up the first connection, or an identifier of the first destination terminal for the transfer of the first connection.

The invention also relates to a system for validating the setting up a first connection between a source terminal and a first destination terminal, or for the transfer of the first connection consisting in setting up a second connection between the source terminal and a second destination terminal, the source terminal and the first and second destination terminals being connected to a communications network interconnecting a plurality of terminals. According to the invention, this system comprises:
means for the detection of a setup-validation or transfer-validation signal
means for determining the first destination terminal to set up the first connection, or the second destination terminal for the transfer of the first connection;
means of reception, through the network, of a setup or transfer indication message, received through the network and comprising parameters of the first connection and an identifier of the source terminal, for setting up the first connection, or an identifier of the first destination terminal, for the transfer of the first connection;
means for the setting up or transfer of the first connection, as a function firstly of information given by said determining means and secondly of the setup or transfer indication message, received by said reception means.

The invention also relates to a system for setting up a first connection between a source terminal and the first destination terminal, or for the transfer of the first connection consisting in setting up a second connection between the source terminal and a second destination terminal. According to the invention, the system comprises: an initialization system as mentioned here above and a validation system as mentioned here above.

The invention also relates to a (first) remote-control unit, contained in a system as referred to here above. According to the invention, this unit comprises:
means for sending a generic signal, constituting both the initialization signal and the validation signal;
means enabling a user to activate the means for sending the generic signal.

The invention also pertains to a (second) remote-control unit, contained in the system as referred to here above. According to the invention, this unit comprises:
means for sending the initialization signal;
means enabling a user to activate the means for sending the initialization signal;
means for sending the validation signal, distinct from the initialization signal;
means enabling a user to activate the means for sending the validation signal.

### BRIEF DESCRIPTION OF THE DRAWINGS

Other features and advantages of the invention shall appear from the following description of a preferred embodiment of the invention, given by way of a non-exhaustive example and from the appended figures, of which:

FIG. 1 shows an example of a home audiovisual network in which the invention can be implemented;

FIG. 2 shows a general view of the hardware architecture of a node appearing in FIG. 1;

FIG. 3 shows an example of a remote-control unit used in the context of the invention;

FIGS. 4a and 4b each show a flowchart describing the different steps of implementation of a particular embodiment of the invention in a node;

FIG. 5 shows another example of a home audiovisual network including a storage device in which the invention can be implemented;

FIGS. 6a and 6b shows flowcharts describing the different steps of implementing another embodiment of the invention;

FIG. 7 shows an example of a first graphic user interface used in the context of the invention;

FIG. 8 shows an example of a second graphic user interface used in the context of the invention.

### MORE DETAILED DESCRIPTION

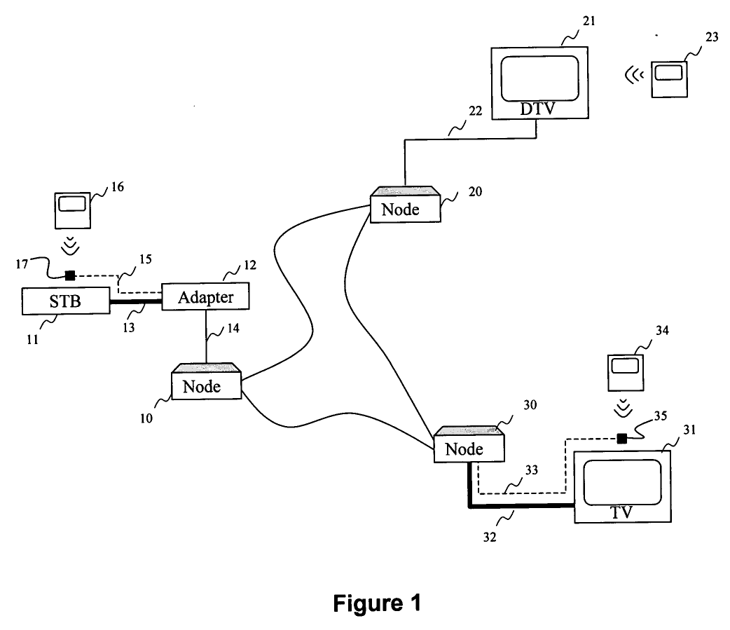

Referring to FIG. 1, an example is presented of a home audiovisual network in which the invention can be implemented. This network has three nodes referenced. 10, 20 and 30, connected to one another by an IEEE 1355 type interface. Each node may have several digital or analog terminals connected to it. In this example of a network, only the terminals and nodes necessary to explain the procedures of the preferred embodiment are represented. In a real case, it is of course possible to have as many terminals and nodes as are permitted by the IEEE 1394 and IEEE P1394.1 standards.

The node referenced 10 has an analog multimedia decoder or “set-top box” connected to it through an adapter 12. The set-top box may be a satellite signal reception demodulator or a pay television decoder for example. The adapter receives the analog audiovisual signals' (AV signals) from the set-top box through an analog interface cable 13. It converts them into digital AV signals that are transmitted to the node referenced 10 by a digital interface cable 14 of the IEEE 1394 type. The set-top box 11 represents a source terminal in the home audiovisual network.

The node referenced 20 has a digital television set 21 connected to it through an IEEE 1394 type digital interface. The digital television set represents a first destination terminal of the home audiovisual network.

The node referenced 30 has an analog television set 31 directly connected to it, on the analog AV interface, through an analog interface cable 32. The node referenced 30 possesses integrated conversion and control functions (it therefore integrates the adapter of the analog television set 31). The analog television set represents a second destination terminal of the home audiovisual network.

The source and destination terminals of the home audiovisual network are associated with control devices, of the infrared remote-control unit type, through which they can be remote-controlled Thus, the remotecontrol units referenced 16, 23 and 34 are respectively associated with the set-top box 11 and with the television sets 21 and 31. With the remotecontrol units referenced 23 and 34 for example, the user can select a channel and change the display or sound parameters of a television set.

In the example of a home audiovisual network presented here, it is assumed-that the control module associated with the set-top box 11 is ‘in the adapter 12, the control module associated with a digital television set 21 is integrated into it and the control module associated with the analog television 31 is integrated into the node 30 of the network.

These control modules are also associated with control devices. Here below in the description, it is assumed that these control devices are integrated into the remote-control units 16, 23 and 34 associated with the terminals 11, 21, 31 of the home network. In addition to their basic commands (intended for the terminals), these remote-control units may therefore generate specific commands intended for the control modules.

When the control module is in a device (adapter or node) independent of the terminal and when the remote-control unit associated with the terminal sends out a directional signal (an infrared signal for example), it may be necessary to relay the control signals that are sent toward the terminal but are intended for the control module. The infrared signal transmission system may for example include a wire 15 or 33, one end of which comprises a signal detector 17 or 35 placed on the terminal (set-top box 11 or television set 31) and the other end of which is connected to the independent device (adapter 12 or node 30). This infrared-signal transmission system is also used by the control module to send commands to the analog terminals, by means of a wire (not shown), one end of which comprises a sender chip (not shown) bonded to the infrared receiver of the terminal (set-top box 11 or television set 31) and the other end of which is connected to the independent device (adapter 12 or node 30).

In a first embodiment as described here below, the invention is implemented in the nodes of a home network.

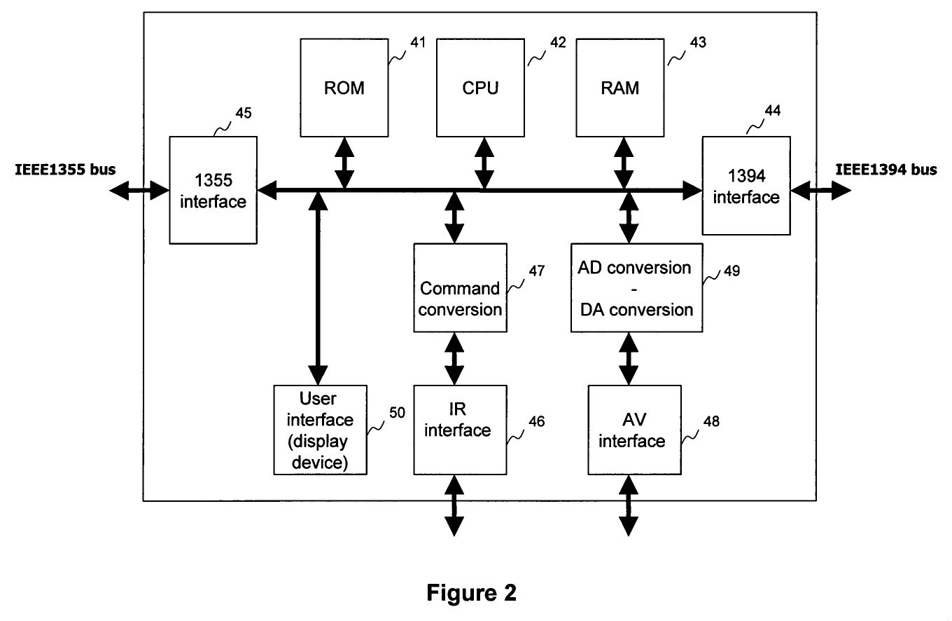

FIG. 2 gives a general view of the hardware architecture of a node. The node comprises:
a permanent memory ROM 41 that saves data processed according to the invention, as well as the program or programs implementing the invention. In one variant, the data and programs may be entirely or partly stored in a persistent (flash) memory or in an internal or detachable disk drive;
a volatile memory or RAM 43;
a processor (CPU) 42 that executes the instructions on the implementation of the invention, instructions stored in the volatile memory or RAM 43;
a module 44 providing an interface (input/output) with the 1394 bus;
a module 45 providing an interface (input/output) with the (IEEE 1355) switched network.

When the system is powered on, the processing programs and the data stored in a permanent memory, for example the ROM 41, are transferred into the volatile memory or RAM 43 which will then contain the executable code of the invention, as well as registers to store the variables necessary for the implementation of the invention.

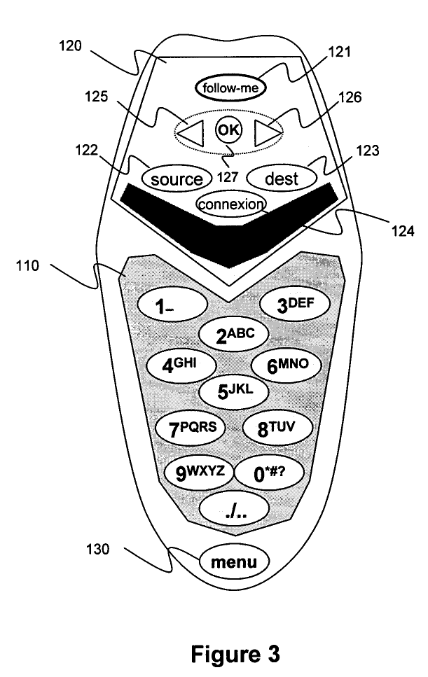

When the node integrates the functions of an adapter, it also comprises:
a module 46 for the reception of infrared (IR) signals, sent by a remotecontrol unit associated with the node (see discussion here below with reference to FIG. 3), and for the sending of IR signals to an analog terminals connected to the node;
a command conversion module 47;
a module 48 providing an interface (input/output) with the analog audiovisual (AV) link;
a module 49 for the analog-digital and digital-analog conversion of AV signals.

The conversion module 49 furthermore comprises MPEG-2 (Moving Pictures Experts Group) signals according to the ISO/IEC 13818-1, 13818-2, 13818-3 standards and DV (Digital Video) signals according to the DV IEC 61834 standard.

The node may also comprise a module 50 providing an interface with the user. This module 50 enables the display, for example, of information on the AV signals relayed’ by the node or the list of terminals connected to this node.

Referring now to FIG. 3, a description is given of an example of a remote-control unit used within the framework of the invention to enable a user to generate infrared commands specific to the nodes 10, 20, 30 of the network and make a connection transfer (here below also called a service transfer).

It is assumed that each node of the network is associated with a remote-control unit of this kind.

Here below in the description, it is assumed that the remote-control unit associated with a given node 10, 20, 30 is integrated into the remotecontrol unit 16, 23, 34 associated with the terminal 11, 21, 31 connected to this given node. Therefore, in addition to their basic commands intended for the terminals (for example the infrared remote-control of a television set or videocassette recorder), the remote-control units 16, 23, 34 associated with the analog or digital terminals can also generate specific commands intended for the nodes 10, 20, 30 (as pieces of equipment in which the invention is implemented, in its first embodiment). It is clear however that the invention also covers the case where the remote-control units associated with the nodes 10, 20, 30 are distinct from the remote-control units 16, 23, 34 associated with the terminals 11, 21, 31.

Such a unit comprises for example three sets of keys:
a first set of alphanumeric keys referenced 110;
a second set of keys referenced 120, comprising specific control keys;
a key referenced 130, by which a user can access a menu, for example a menu of complementary functions that could be implemented within the audiovisual network of the invention, but shall not be described in greater detail in the context of the present invention.

The set of command keys referenced 120 comprises for example:
a “follow-me” button referenced 121 to initiate or terminate a service transfer. Here below, the term “follow me” remote-control signal shall be applied to the signals sent when the user presses this button 121;
a “source” button referenced 122 to select a source terminal;
a “dest” button referenced 123 to select a destination terminal;
a “connection” button referenced 124 to set up or break a connection between a source terminal and a destination terminal that have been pre-selected;
navigation buttons 125 and 126 to scan a list of several terminals or channels in the context of a selection;
an “OK” button referenced 127 to validate the choice of an element of a list or of a menu.

It may be recalled that the connection transfer (transfer of an AV signal) from a first destination terminal to a second destination terminal is aimed at changing the connection initially set up between the source terminal and the first destination terminal into a new connection between the same source terminal and the second destination terminal or juxtaposing this initial connection with a new connection.

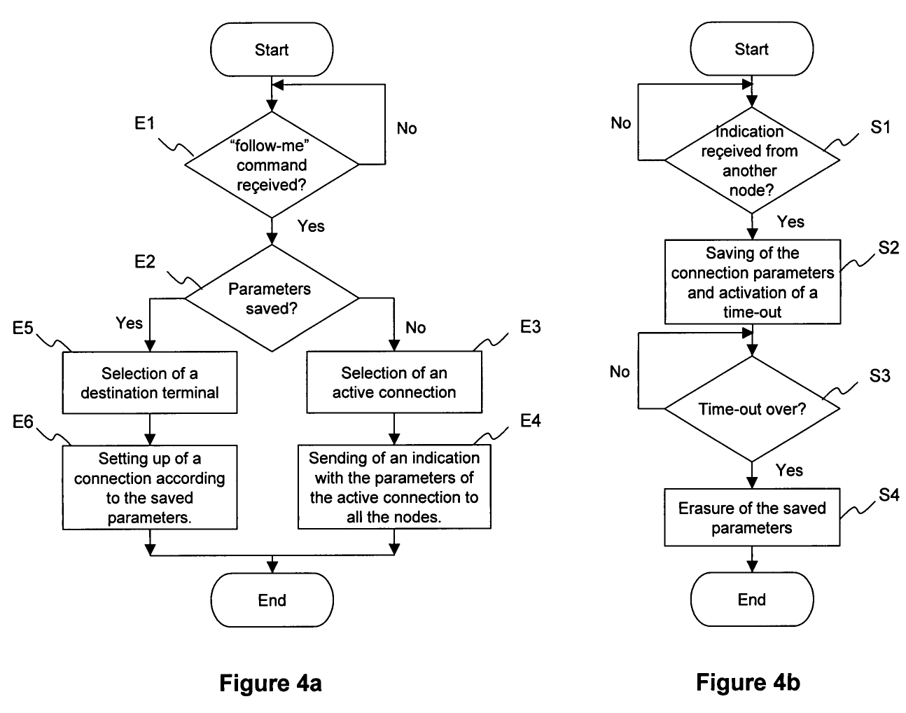

In the first preferred embodiment, the user initiates the transfer of the signal in using the “follow me” button 121 of the remote-control unit associated with the link-up node of the first destination terminal (i.e. the node to which this first destination terminal is attached) and selects the AV signal to be transferred. The user than selects the second destination terminal and validates the transfer of the AV signal by using the “follow me” button 121 of the remote-control unit associated with the link-up node of the second destination terminal. FIGS. 4a and 4b provide a detailed view of the procedures of this first embodiment of the invention.

FIG. 4a describes the different steps implemented in a node 20, 30 of the home network of FIG. 1, when it receives a “follow me” remotecontrol signal coming from a remote-control unit 23, 34 associated with this node (by means of the infrared module 46 of FIG. 2).

When the node 20, 30 receives a “follow me” remote-control signal during a step referenced E1, it carries out the test during the step E2 to determine whether the connection parameters have been saved by the node. The parameters of a connection contain all the information necessary for a controller to set up this connection. These parameters can be part or: all of the following: the identifier of the source terminal, the identifier of the destination terminal, the identifier of the audiovisual signal (“stream” or “channel” identifier for example) and the bandwidth necessary for conveying the AV signal (see the steps E4 and S2 of FIG. 4b on the conditions of the conveying and saving of these parameters). This list is not exhaustive.

If, during the test at the step E2, no saved parameters have been found by the node, the “follow me” remote-control signal is then interpreted as indicating the start of a transfer (transfer-initializing signal), and the node performs the steps E3 and E4. In the above-mentioned example, this is the case of the node referenced 20 to which the digital television set 21 representing the first destination terminal is connected.

During the step E3, the user must then select the connection to be transferred. As a connection is used to transport one audiovisual signal, the step of selecting refers also to that transported signal. In the following, both one and the other may be used.

For example, the selection is made by means of the module 50 providing an interface with the user (cf. FIG. 2), which indicates the name of the destination terminal and/or the identifier of the channel that the user may select. Should the user have no display means, the information on the user's wish to make a service transfer may be directly overlaid on the audiovisual signal on the destination terminal (through the “on-screen display” technique). An example of information displayed on the destination terminal is a request for confirmation of the transfer. When the user makes a transfer request, he makes the AV channels or other channels scroll until the information confirming transfer is displayed on the terminal displaying the desired AV signal. At this point in time, all the user has to do is to confirm his transfer request, for example with the “OK” button of the remote-control unit.

In one alternative embodiment, the step for selecting a connection is made only if there is more than one active connection transporting its associated AV signal through the node and towards a terminal connected to this node. In other words, if there is only one active connection, it can be selected by default.

During the step E4, when an active connection has been selected, its parameters are communicated through an indication message broadcast to all the other nodes of the backbone network. The connection with the first destination terminal may or may not be maintained after the transfer, depending on the user's wishes. For example, the connection is broken only if the terminal is placed on standby, and is maintained otherwise.

If, during the test at the step E2, the node finds a saving of connection parameters, the remote-control signal “follow me” is interpreted then as indicating the termination of a transfer (transfer-validation signal), and the node performs the steps E5 and E6. In the above-mentioned example, this is the case of the node referenced 30 to which the analog television set 31, representing the second destination terminal, is connected.

During the step E5, the user must then select the second destination terminal. For example, the selection is made by means of the module 50 providing an interface with the user (cf. FIG. 2), which indicates the name of the destination terminal that the user may select.

In one alternative embodiment, for example when the node does not have any display means, the destination terminal is chosen by default, like for example the analog output AV of the node (referenced 48 in FIG. 2).

During the step E6, the controller (integrated into the node, ‘in the example described here) sets up a connection, with the parameters previously saved by the node between the source terminal and the selected destination terminal. Furthermore, after the new connection has been set’ up, the node erases the previously saved parameters.

FIG. 4b describes the different steps implemented in each of the nodes of the backbone network to process a transfer indication message broadcast by another node (cf. step E4 of FIG. 4a described here above). Each node receives this transfer indication message by means of the interface module referenced 45 in FIG. 2.

During the step S1, the node goes into a state of waiting for reception of an indication message.

When an indication message is received, then, at the step S2, the node saves the parameters of the connection that are contained in the message and activates a time-out procedure. The nodes that cannot or do not wish to make the transfer can ignore the indication and perform no parameter-saving operation.

During the step S3, the node determine the point in time at which the time-out has expired, and when this is the case, during the step S4, it erases the parameters saved beforehand.

The time-out prevents confusion between two transfers when the parameters are excessively dated. The value of this time-out period may be the maximum time of movement of the user between the two most distant terminals in the home network.

After the transfer has been made, the parameters are erased in the link-up node of the second destination terminal. In the other nodes, the erasure- is done after the expiry of the time-out period.

In one alternative embodiment (which can be implemented alone or in combination with the time-out mechanism), the link-up node of the second destination terminal sends a transfer confirmation message to all the other nodes, enabling them to immediately erase the saved parameters (without waiting for the expiry of the time-out).

In another alternative embodiment, the set-up of the connection between source terminal and the second destination terminal is handled by the link-up node of the first destination terminal (or the first destination terminal itself). In this embodiment, after the selection of the second destination terminal, a set-up message is transmitted to the link-up node of the first destination terminal to make this node establish a connection between the source terminal and the second destination terminal.

The first embodiment, described here above, of the service transfer method according to the invention is appropriate when the number of users is limited, i.e. when the probability of having two users or more wishing to make a service transfer service is limited.

It is clear that many other embodiments of the invention can be envisaged.

It is possible especially to provide for a second embodiment of the invention, enabling the management of several users performing simultaneous transfers, without confidentiality between the users. Just as in the first embodiment described here above, the invention is implemented in the nodes of the home network.

In this second embodiment, the remote-control unit associated with each node (as a piece of equipment implementing the invention) has two buttons instead of the “follow me” button (<<follow-me>>) referenced 121 in FIG. 3. These two buttons enable the sending of two types of remotecontrol to the node. The first of these two buttons (“Get”) enables the sending of a transfer-initialization signal. The second (“Push”) button is used to send a transfer-validation signal.

Thus, the user can successively select several connections, in pressing the first button “Get” several times, regardless of whether or not the transfers have been validated with a link-up node of a second destination terminal. In other words, the reception of a new indication message by a node does not erase the parameters of previously received indication messages from this node.

The successive selections of connections to be transferred may be made by different users or by the same user, at a same node or at different nodes.

Each node thus maintains a list of connections (for each of which it has received a transfer indication message), with the parameters of each of these connection (between three and five for example). If the node or the terminal has a means of displaying this list, then when a user selects the destination terminal (destination of the transfer), he can obtain the scrolling of the list of connections whose parameters have been saved and then activate only the item corresponding to the connection whose transfer is desired. When there are no display means, the user, by pressing the abovementioned second button (“push”) of the remote-control unit several times, can successively activate the different connections, present in the list, at the destination terminal. In this case, it is enough for the user to stop when the desired connection is in progress. The items of the above-mentioned list can be erased by implementing a time-out mechanism of the type described here above for the first embodiment.

In this second embodiment, each user can obtain knowledge of and activate connections selected by other users (this is transfer without confidentiality).

Optionally, provision can be made for complementary steps and means for the management of several users making simultaneous transfers with confidentiality between the users. This option can be implemented with the first and second embodiments described here above. In this case, immediately after the selection of the connection to be transferred (the step E3, FIG. 4a), the user finishes a confidential code, for example by also pressing any unspecified series of digits on the remote-control unit. This confidential code serves to identify the user. It will form part of the parameters of the connection to be transferred and will be transmitted in the indication message (step E4, FIG. 4a). If this code has already been chosen by another user, the terminal can indicate it by means of the signal (a sound signal for example). During the selection of the destination terminal (step E5, FIG. 4a), the user must also give the confidential code, for example in following this selection by pressure on the same series of digits on the remote-control unit, to validate the transfer of the connection. In other words, the confidential code entered by the user is compared by the node with the confidential code contained in the indication message received, and it is only if these two codes are identical that the node validates the transfer (i.e. informs the controller that the new connection must be set up).

In one variant, it is the link-up node of the first destination terminal that generates and displays a series of digits (a code) when the user selects the connection to be transferred (step E3, FIG. 4a). When selecting the destination terminal (step E5, FIG. 4a), the user must reintroduce this same series of digits to transfer the selected connection. The node must generate a series of digits that must be unique for a given connection. For example, the node may generate a random series, and take it into account only if it is different from those generated by the other nodes (the initially random choice reduces the probability that two series will be identical when two terminals generate their series at the same time or almost at the same time).

In the first and second embodiments described here above, the invention is implemented in the nodes of the home network.

In one alternative embodiment, the invention is implemented in the digital terminals and in the adapters of the analog terminals of the home network. The advantage of this variant is that the step for selecting the connection inprogress (a connection for an AV signal for example) at the first destination terminal, and the step for selecting the second destination terminal, are simplified. Indeed, by pointing the remote-control unit directly at the chosen terminal, the user selects only the connection in progress on this terminal, during the phase of initialization of the transfer (step E3, FIG. 4a), and selects this terminal as being a second destination terminal, during the phase of validation of the transfer (step E5, FIG. 4a).

It is also possible to plan for different combinations of this variant of the basic embodiment, in implementing the invention in at least certain nodes and/or at least certain digital terminals and/or at least certain adapters of the analog terminals.

Furthermore, the present invention also proposes a solution to the problem of setting up a connection between a source terminal and a (first) destination terminal.

The entire illustrative description given above with reference to the figures relates to the transfer of a connection from a first destination terminal to a second destination terminal. This transfer is aimed at changing the first connection (assumed to be already set up) between the source terminal and the first destination terminal into a second connection between the same source terminal and the second destination terminal or at juxtaposing this first connection with a second connection.

This illustrative description can easily be transposed to the setting up of a connection between the source terminal and a destination terminal. Indeed, it is sufficient for this purpose to assume that the source terminal and the first destination terminal, in the case of the setting up of the first connection, play the same role respectively as the first and second destination terminals in the case of the transfer of the first connection.

In the embodiments described above a storage service may also be provided to prevent from losing data when an audiovisual signal is to be transferred from a first destination terminal to a second destination terminal.

In the following, a third embodiment is provided to describe an alternative solution for transferring an audiovisual signal involving network storage means.

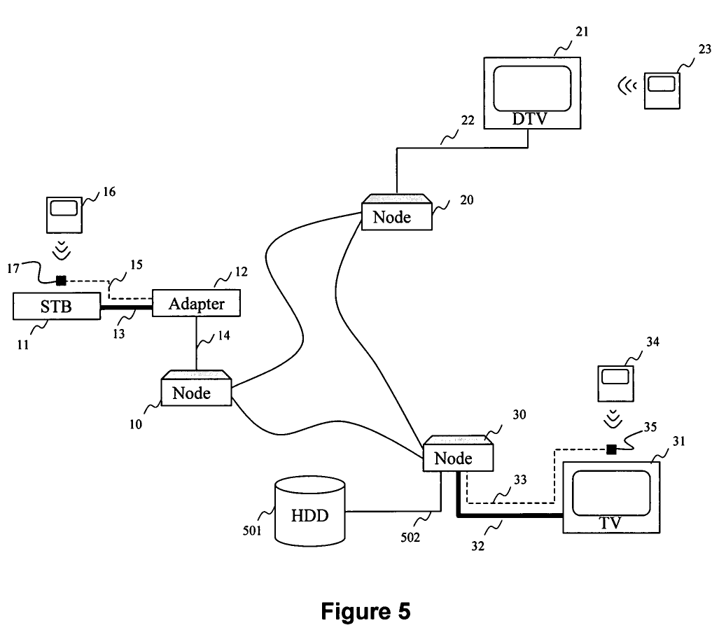

FIG. 5 describes an example of a home audiovisual network including a storage device. The description of this figure is similar to that of FIG. 1. Additionally, a storage unit 501 is connected to node 30 using for instance IEEE 1394 cable 502.

In this third embodiment, the remote-control unit associated with each node is assumed to have two buttons “Pause” and “Resume”.

The first of these two buttons (“Pause”) enables the sending of a transfer and storage initialization signal. So in addition to the initialization of the transfer, the audiovisual signal is redirected to the storage device. If the storage device is not a local device, a connection is established to forward the signal from the first destination terminal to the storage device.

The second button (“Resume”) enables the sending of a transfer and reading validation signal. The audiovisual signal previously stored in the storage device is read and directed to the second destination terminal.

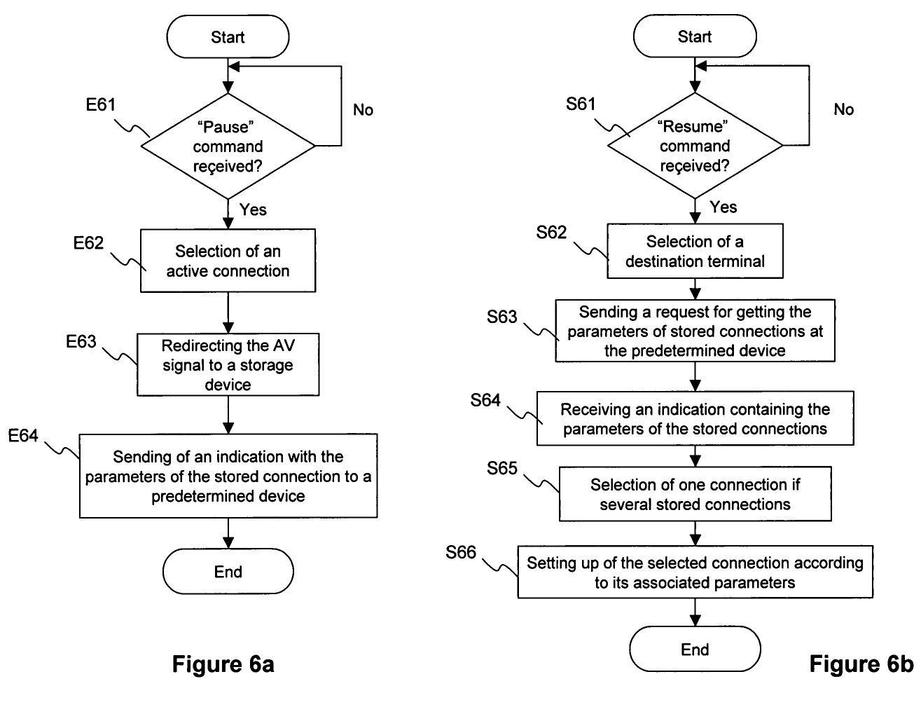

FIG. 6a describes the different steps implemented in a first destination device (either the first destination terminal or the node to which is connected the first destination terminal). The reception of a “Pause” remote-control signal corresponds to the transfer and storage initialization signal (step E6 1). In step E62 the first destination device selects the connection to be transferred similarly to step E3 of FIG. 4a.

During a step E63 the audiovisual signal is redirected to the storage device by establishing a connection to that storage device.

Optionally, a connection may be established directly from the source device to the storage device. This establishment should be however performed such as not losing any data of the audiovisual signal.

During a step E64, an indication message containing the parameters of the connection (including the identifier of the storage device to which the audiovisual signal was directed) is transmitted to a predetermined device.

The transmission of the indication message to a predetermined device is a centralized approach that differs from the distributed approach provided in the above first and second embodiments. Either approach can be applied to each embodiment. In the centralized approach the reception of an indication messages is effected only upon request after the transmission of a request message to the predetermined device. This latter device stores the parameters of all the connection that are on hold (transfer in progress). These parameters can be kept permanently, temporarily or only up to the point in time where the connection is transferred.

FIG. 6b describes the different steps implemented in a second destination device (either the second destination terminal or the node to which is connected the second destination terminal). The reception of a “Resume” remote-control signal corresponds to the transfer and read validation signal (step S61).

During step S62 the user must select the second destination device similarly to step E5 in FIG. 4a.

During step S63 the second destination device sends a request for getting the parameters of the stored (“paused”) connections at the predetermined device. Following that request one or more indication messages are received at step S64. When a plurality of connections were stored, either one indication message is received by the second destination device containing a list of set of parameters, each set of parameters being associated to an audiovisual signal or connection; or several indication messages are received containing each one set of parameters (one indication message associated to one audiovisual signal or connection).

If a plurality of connections were stored in that device, a selection is necessary for determining which paused audiovisual signal is to be retrieved from the storage device (step S65). This selection can be performed by scrolling a list of audiovisual signals for example.

After the selection of an audiovisual signal a connection is set up between the storage device and the second destination device to retrieve that audiovisual signal (S66).

It should be noted that the “Pause” and “Resume” remote-control signals are not necessarily to be used only for the transfer of a connection from a first destination device to a second destination device (“follow-me” function”). These signals can also be used only for time-shifting the display of an audiovisual signal if the user continue the viewing of this AV signal on the same destination device.

Consequently there is only a “time-shift” function if the first destination device and the second destination device are one and the same, and a “time-shift” in addition of a “follow-me” function if they are different.

In one alternative embodiment, the step S65 in FIG. 6b can be optimized to simplify user interactions so that he/she can more easily retrieve the relevant audiovisual signal.

In this embodiment, the second destination device (either when solely performing a time-shifting function or in addition with a follow-me function) constructs a list of set of parameters, each set of parameters being associated to an audiovisual signal or connection (refer to step S64 in FIG. 6b). For each “paused” audiovisual signal is provided an information indicative on whether or not this signal is local or remote relatively to the device from which is performed the selection (second destination device).

Thus, for a time-shifting function only (first and second destination devices are the same) the paused audiovisual signal is referred to as local, and for a follow-me function with a time-shifting (first and second destination devices are different) the paused audiovisual signal is referred to as remote.

The indicative information is used to help the user select the appropriate audiovisual signal for example by ordering the list of audiovisual signals provided for selection (step S65).

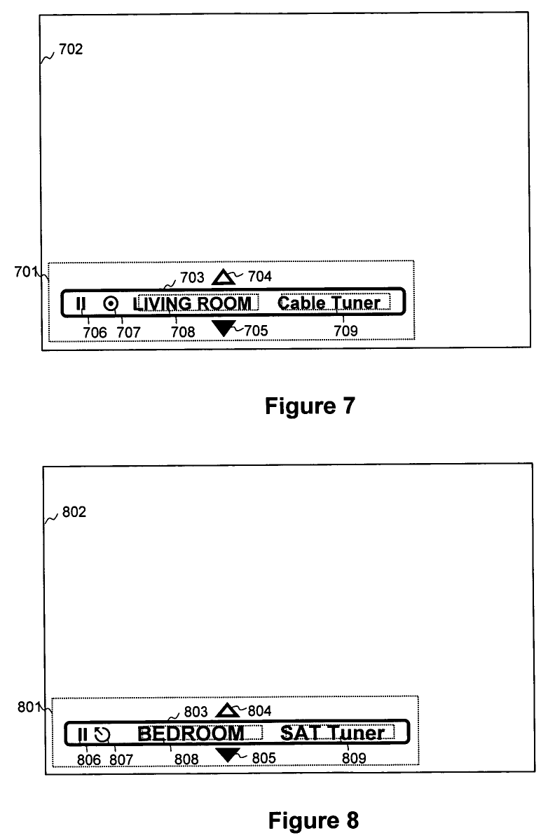

FIGS. 7 and 8 provide an illustrative example how the indicative information is used in the selection step S65.

FIG. 7 describes an example of graphic user interface 701 that is displayed when pressing the “Resume” button in front of a destination device in case of a local time-shift function. User interface 701 is rendered within display area 702 and presents a list of one or more paused audiovisual signals. It includes navigation arrows 704 and 705 to visualize respectively previous and next paused AV signal(s) from the list (note that black arrow means there are still other AV signal(s) to be accessed whereas white arrow means there is no more AV signals). The following items may be displayed that correspond to part of the elements of the set of parameters associated each AV signal of the list:
Status 706, for instance “pause” means the AV signals is not yet retrieved at the destination device;
Indicative information 707, for instance “local”;
Node name 708 (or room name) to which the source terminal is attached;—Source terminal name 709.

FIG. 8 describes a second example of graphic user interface 801 that is displayed when pressing the “Resume” button in front of a destination device in case of a remote time-shift and follow-me function. This user interface is similar to the one of FIG. 7, but for indicative information 807 that corresponds to “remote”.

In one preferred embodiment, the AV signals which have an indicative information corresponding to “local” are displayed before those having an indicative information corresponding to “remote”. This facilitates the selection for the user.

In another embodiment one additional parameter may be used to build the list of paused AV signals in order to know whether a paused AV signal has already been resumed or not. For instance the list can be ordered to present first all AV signals that have been never resumed and followed by the AV signals that have already been resume at least once and were not removed from the list to be reused by other users.

1. A method for communicating audiovisual signals over a communication network interconnecting a plurality of devices, wherein the method comprising the steps of:
selecting an audiovisual signal at a first device;
transmitting an indication message from the first device to a group of devices over the communication network, said indication message containing a set of parameters associated to the selected audiovisual signal;
selecting a second device among the group of devices, said selection being performed at said second device; and
establishing a connection for retrieving at the selected second device the audiovisual signal using at least one of the set of parameters.

2. A method for communicating audiovisual signals over a communication network interconnecting a plurality of devices, wherein the method comprising the steps of:
selecting an audiovisual signal at a first device;
transmitting an indication message from the first device to a predetermined second device over the communication network, said indication message containing a set of parameters associated to the selected audiovisual signal; and
selecting a third device among the plurality of devices, said selection being performed at said third device;
transmitting a request message for getting from the predetermined second device it least one of the set of parameters associated to the selected audiovisual signal; end
establishing a connection for retrieving at the selected third device the audiovisual ;ignal using the at least one of the set of parameters.

3. A device for communicating audiovisual signals over a communication network interconnecting a plurality of devices, comprising:
means for inputting first selection data causing the selecting of an audiovisual signal;
means for transmitting an indication message to a group of devices over the communication network, said indication message containing a set of parameters associated to the selected audiovisual signal;
means for receiving a set-up message regarding the selected audiovisual signal from at least one device of the group of devices; and
means for causing to establish a connection for the at least one device in response to the received set-up message to retrieving the selected audiovisual signal.

4. A device for communicating audiovisual signals over a communication network interconnecting a plurality of devices, comprising:
means for receiving one or more indication messages, each indication message containing a set of parameters associated to an audiovisual signal;
means for inputting first selection data causing the selecting of a destination device;
means for determining one audiovisual signal from a list of audiovisual signals, the list being formed based on the received indication messages; and
means for establishing a connection for retrieving at said destination device the audiovisual signal in response to the determination means using at least one of the set of parameters.

5. Device according to claim 4, wherein the set of parameters comprises the identifier of an original destination device and said device comprises further a means for outputting indicative data for indicating if the identifiers of the original destination device and the selected destination device are equal or not.

6. Device according to claim 4, wherein the determining means comprises:
means for inputting second selection data; and
means for selecting the one audiovisual signal among the list of audiovisual signals using said second selection data.

7. Device according to claim 4, wherein it further comprises a transmitting means and wherein the receiving of one or more indication messages by the receiving means is performed in response to the transmitting of a request message by the transmitting means.

8. A computer program product, comprising program code instructions for the execution of the steps of a method for communicating audiovisual signals over a communication network interconnecting a plurality of devices, said program code instructions executed on a computer, the computer program product comprising:
first instructions for receiving one or more indication messages, each indication nessage containing a set of parameters associated to an audiovisual signal;
second instructions for inputting first selection data causing the selecting of a destination device;
third instructions for determining one audiovisual signal from a list of audiovisual signals, the list being formed based on the received indication messages; and
fourth instructions for establishing a connection for retrieving at said destination device the audiovisual signal in response to the determination means using at least one of the set of parameters.
